(19) United States
(12) Patent Application Publication
(10) Pub. No.: US 2014/0115565 A1
(43) Pub. Date: Apr. 24, 2014

(54) TEST SIMILARITY DETECTION WITH METHOD CALL SEQUENCE ANALYSIS

(71) Applicant: MICROSOFT CORPORATION, Redmond, WA (US)

(72) Inventors: Arun Abraham, Redmond, WA (US); Patrick Tseng, Kirkland, WA (US); Vu Tran, Renton, WA (US); Jing Fan, Redmond, WA (US)

(73) Assignee: MICROSOFT CORPORATION, Redmond, WA (US)

(21) Appl. No.: 13/655,114

(22) Filed: Oct. 18, 2012

(51) Int. Cl. G06F 9/44

(52) U.S. Cl. 717/128; 717/131

(57) ABSTRACT

A computer-implemented method for detecting test similarity between first and second tests for a software system. The computer-implemented method includes receiving data indicative of respective method call sequences executed during each of the first and second tests, generating, with a processor, a similarity score for the first and second tests based on a comparison of the respective method call sequences, and providing, via a user interface, a result of the comparison based on the similarity score.

### BACKGROUND OF THE DISCLOSURE

### Brief Description of Related Technology

Software products are commonly developed in test-driven development (TDD) processes. In a TDD process, an automated test case, or unit test, is written in connection with the definition of a new function of the software product. Unit testing provides a framework to create and run a number of test cases to test the functionality of respective components or sections of code. At times in TDD processes, it is useful to consider whether particular portions of the code are implicated by the tests. So-called code coverage information indicates which blocks of application code are executed during a test. Knowledge of which blocks were executed, or not executed, may also indicate to a developer where further test development is warranted. Code coverage information thus frequently prioritizes test development efforts.

Big code bases often have a large number of tests. Unit testing frameworks and TDD processes have also led to extensive test suites. Unfortunately, with each additional test, it often becomes increasingly difficult to maintain the product code. It is not uncommon to find, especially in larger code bases, that a small product change results in a much larger and more complex change to the test suite.

### SUMMARY OF THE DISCLOSURE

Methods, systems, and computer program products are directed to detecting redundancy or other similarity between tests. Similarity may be detected based on an evaluation of method call sequences. A similarity score may be generated based on a comparison of method call sequence data.

In accordance with one aspect of the disclosure, data indicative of respective method call sequences is compared to generate a similarity score. One or more results of the comparison may be provided via a user interface.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### DESCRIPTION OF THE DRAWING FIGURES

For a more complete understanding of the disclosure, reference should be made to the following detailed description and accompanying drawing figures, in which like reference numerals identify like elements in the figures.

FIG. 1 is a block diagram of an exemplary development system configured to develop and analyze software system tests in accordance with one embodiment.

FIG. 2 is a flow diagram of an exemplary computer-implemented method to detect similar software system tests in accordance with one embodiment.

FIG. 3 is a block diagram of a computing environment in accordance with one embodiment for implementation of one or more of the disclosed methods and systems.

While the disclosed systems and methods are susceptible of embodiments in various forms, there are illustrated in the drawing (and will hereafter be described) specific embodiments of the invention, with the understanding that the disclosure is intended to be illustrative, and is not intended to limit the invention to the specific embodiments described and illustrated herein.

### DETAILED DESCRIPTION

The disclosed methods and systems are directed to detecting test clones or other similar tests of a software system. Similar tests may be detected using method call sequence data. In some cases, test similarity is determined based on a combination of method call sequence data and code coverage data.

The disclosed methods and systems may be useful in connection with software systems having a large number of tests. For example, large numbers of tests may be present as a result of the application of one or more unit testing frameworks and/or TDD processes, which may, over time, lead developers to write multiple tests that end up testing the same blocks of code. By detecting redundant and other similar tests, the disclosed methods and systems may support the simplification of the test suite. The disclosed methods and systems may help keep the test bed lean and remove as much test duplication as possible. The software system may accordingly become easier to maintain. Limiting the extent to which tests overlap in coverage may also make changes to the production code easier to achieve.

The disclosed methods and systems may detect test clones or other test similarity based on analysis of method call sequence data generated or collected during execution of the tests. In some cases, additional runtime data may also be analyzed. For example, code coverage data may be analyzed in addition to the method call sequence data. Any pair of tests may thus be analyzed along one or more dimensions of the runtime characteristics of the tests. Analyzing a combination of different runtime characteristics (e.g., code coverage and method call sequence) may provide a more accurate indication of the extent to which the pair of tests are clones or otherwise duplicative or similar.

Although described in the context of tests run against binary code, the disclosed methods and systems may be used with a wide variety of software system types, languages, architectures, and frameworks. For example, the disclosed methods and systems are well suited for use with various unit test frameworks. The execution environments of the software system may also vary. For example, the disclosed methods and systems are not limited to any one particular operating system or environment. The reports, alerts, and other results generated by the disclosed methods and systems may include or involve a wide variety of user environments and/or interfaces and are not limited to any particular output or interface device or system.

Although described in connection with technologies or procedures available via Visual Studio® software available from Microsoft Corporation, the disclosed methods and systems are not limited to a particular integrated development environment (IDE). For example, the disclosed methods and systems are not limited to using the Test Impact and/or IntelliTrace features of Visual Studio® software to collect the runtime data on the tests. The disclosed methods and systems may be used with different types of IDE systems.

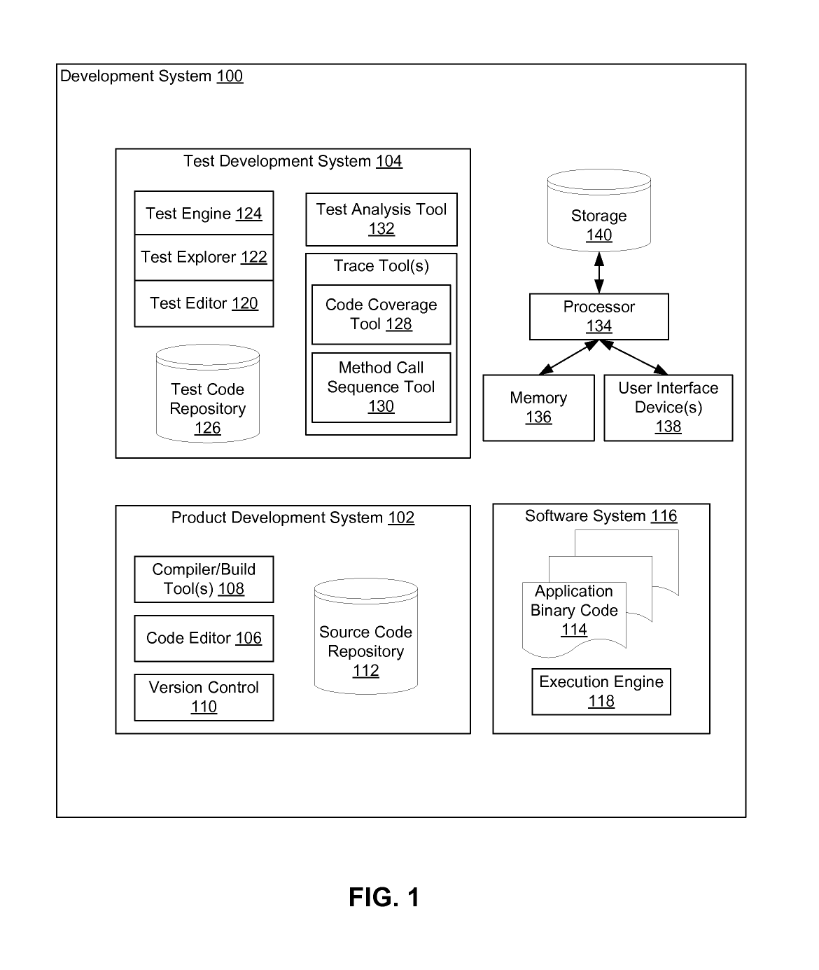

FIG. 1 depicts one example of a development system 100 in which test clones or other similarities between tests are detected in accordance with one embodiment. The development system 100 includes a product development system 102 and a test development system 104. The product development system 102 is configured to develop software applications, solutions, or other products, the functionality of which may then be tested by tests developed via the test development system 104. The nature of the software product under development may vary. The test development system 104 may be configured to implement one or more test analysis procedures or methods to determine the extent to which any tests are duplicative or otherwise similar, as described below. The product development system 102 and the test development system 104 may be integrated to any desired extent.

The product development system 102 may provide a number of features, services, or procedures to support the development process. In this example, the product development system 102 includes a code editor 106, a compiler and/or other build tools 108, and a version control system 110. Additional, fewer, or alternative tools or features may be included. A developer may use the code editor 106 to generate source code, the versions of which may be stored in a source code repository 112 via the version control system 110. The compiler and other build tools 108 may process the source code to generate one or more application binary code files 114. In this example, the application binary code files 114 are stored as part of a software system 116 that provides an environment in which the software product under development may be executed or run. The software system 116 may include an execution engine 118 and/or other components to support the execution of the software product under development. The execution engine 118 may include one or more additional binary or other executable files to support the execution of the software product. For example, the execution engine 118 may include components of, or interface with, an operating system or other framework or environment in which the binary code files 114 are executed. In some embodiments, one or more aspects or components of the execution engine 118 are external to the software system 116.

The test development system 104 is configured to develop tests for the software solutions or products under development. The tests may be unit tests or any other type of test. In unit test examples, the unit testing framework may vary. For example, the test development system 104 may be configured to support test development in accordance with the NUnit testing framework, the xUnit testing framework, and/or any other unit testing framework. The test development system 104 includes a number of components or modules for creating and executing the tests. In this example, the test development system 104 includes a test editor 120, a test explorer 122, a test execution engine 124, and a test code repository 126. A developer may use the test editor 120 to generate source or other code for the tests, which may be stored in the test code repository 126 for subsequent access (e.g., editing) via a user interface provided by the test explorer 122. The code of each test may be configured as a test case for one or more functions of the software product under development. In an example involving a software product developed in an object-oriented environment, the test code may specify a number of parameters to be used in executing a particular class of the software product. The test code may be written in any language. The disclosed methods and systems may be used with any type or set of test tool methods.

One or more tests may be executed via the test execution engine 124, which may be configured to access the test code repository 126 to compile and/or otherwise process the test code for execution. The tests may be run against the application binary code files 114. The test execution engine 124 may be configured to execute multiple tests in an automated fashion. For example, the test execution engine 124 may default to executing each of the tests associated with a particular software product or solution under development. Results of the tests may be provided via the user interface of the test explorer 122, or via one or more other user interfaces generated by the test development system 104.

The test development system 104 also includes a number of tools configured to generate data in connection with execution of the tests. The data may include trace data indicative of an execution path achieved during the test. In this example, the test development system 104 includes a code coverage tool 128 and a method call sequence tool 130. Additional, fewer, or alternative tools may be provided. For example, the test development system 104 may include any number of tracing tools to provide trace data. The trace data may alternatively or additionally include data indicative of errors encountered during the test.

In the example of FIG. 1, the code coverage tool 128 may provide code coverage information for each executed test. The code coverage information may be indicative of the blocks of code of the software product that are run (and/or not run) during execution of the test. The code coverage information may be provided via a user interface generated by the code coverage tool 128 (e.g., a code coverage results viewer) or via another user interface provided by the test development system 104. Data indicative of the code coverage information may be stored in a file, such as a coverage file created during execution of the test. The file may be opened for analysis and processing via an application programming interface (API), e.g., an API of the Visual Studio® environment, configured to determine the code coverage results. The code coverage data may be arranged as a mapping of a set of blocks to respective Boolean values indicative of whether a block is hit during the test. Each block may be associated with one or more processor instructions that are executed together. A method or function may include one or more blocks. In some cases, the code coverage data may be aggregated up to higher level constructs, such as methods, classes, namespaces, and assemblies. The resolution of the code coverage data may thus vary. For example, the code coverage information may be provided on a line-by-line basis, a block-by-block basis, or other basis. The manner in which the code coverage data is generated may vary.

The method call sequence tool 130 may provide data indicative of the sequence in which method calls occurred during execution of a test. In embodiments using Visual Studio® software, the method call sequence data may be generated by the IntelliTrace tool or feature. A result file may be accessed via an API for analysis and processing to determine the method call sequence. Additional or alternative tools may be used to generate the data. The method call sequence data may include a list of the method calls in the order in which the calls are implemented. The data may be stored as a tree or other hierarchy of method call invocations, such as:

TestMethod

Method1

NestedMethod2
NestedMethod3

FurtherNestedMethod4

NestedMethod4

Method2

NestedMethod5

Analysis of the hierarchy may provide an indication of when method call sequences include loops or other sequence arrangements that may be compressed or otherwise recognized to improve the accuracy of the comparison.

The data indicative of the code coverage information and the method call sequences may be referred to herein as trace data. The term “trace data” is used in a general sense to indicate that the data provides information that indicates a trace, path, or other set of locations in the software system 116 achieved or reached during execution of a test.

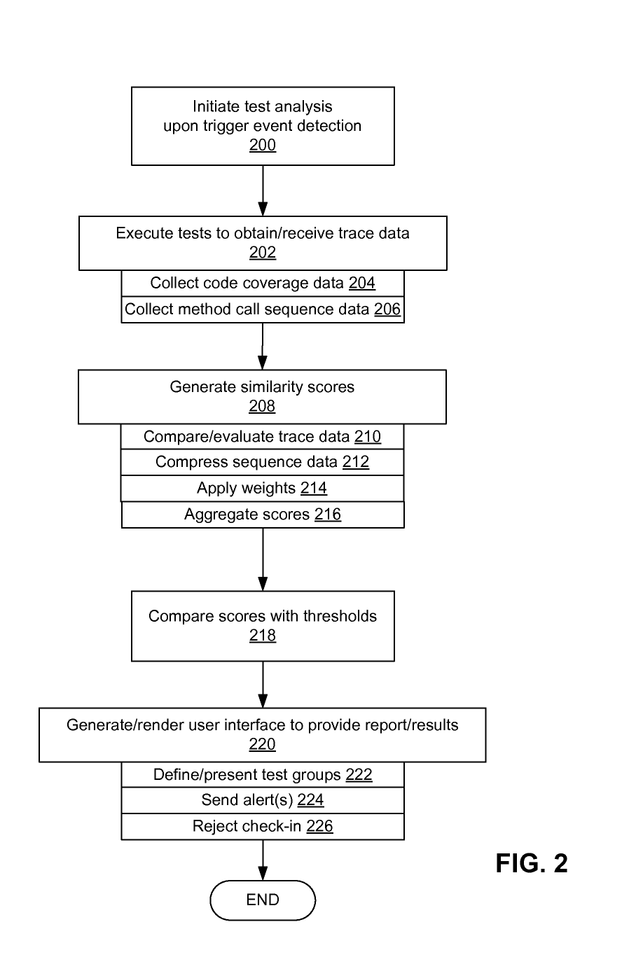

The test development system 104 also includes a test analysis tool 132 to implement one or more analyses of the trace data. For example, the test analysis tool 132 may be configured to analyze the code coverage data and/or the method call sequence data generated in connection with a pair of tests. The analysis may be configured to determine the extent to which the pair of tests are identical, redundant, or otherwise similar. The test analysis tool 132 may be configured to generate a similarity score based on an evaluation of the code coverage and/or method call sequence data. The analysis provided by the test analysis tool 132 may include processing the trace data generated during the tests in preparation for the evaluation. For example, and as described below, the method call sequence data may be compressed to facilitate a comparison of the sequences for the tests. The test analysis tool 132 may also be configured to generate a report, message, or other result based on the comparison, similarity score, or other evaluation or analysis. Further details regarding the features and aspects of the test analysis tool 132 are provided below in connection with the method of FIG. 2.

The test analysis tool 132 may be integrated with the above-described trace tool(s) of the test development system 104 to any desired extent. The test development system 104 may include multiple test analysis tools. For example, a respective test analysis tool may be provided for each type of trace data evaluated. Some of the features of the test analysis tool 132 may be provided or handled by other components of the test development system 104. For example, features related to generating an output or other result of the test analysis may be provided or supported by the test explorer 122 and/or the test engine 124.

The development system 100 includes a number of hardware components used to implement the tools, features, technologies, and other aspects of the product development system 102, the test development system 104, and the software system 116. In this example, the development system 100 includes a processor 134 (or processing system) and a number of components in communication therewith or otherwise coupled thereto, including a memory 136, one or more user interface devices 138, and a data storage device 140 (or other memory). The processor 134 may be used to implement one or more aspects of the test analysis procedures of the disclosed methods and systems. The memory 136 and/or the data storage device 140 may store instructions to direct the processor 134 in the implementation of the procedures. The user interface devices 138 may be used by a developer to initiate the procedures, retrieve output information or other results of the procedures, and/or otherwise interact or control the disclosed methods and systems.

The hardware components of the development system 100 may be integrated with the above-described features of the product development system 102, the test development system 104, and the software system 116 to any desired extent. For example, the source code repository 112, and the binary code files 114, and the test code repository 126 may be configured as databases, data structures, or other items stored in the data storage device 140. Instructions for implementing the other tools, components, elements, and aspects of the product development system 102, the test development system 104, and the software system 116 may also be stored in the data storage device 140. In operation, the data storage device 104 may be accessed by the processor 134 to retrieve the instructions for execution. A representation of the instructions may be temporarily stored in the memory 136 during runtime processing. The data storage device 140 may alternatively or additionally be used to store data generated during the implementation of the product development system 102 and the test development system 104. For example, trace data and/or other results of the tests may be stored in the data storage device 140.

The user interface devices 138 may include a data display device and/or any other output user interface. Operators or other users of the development system 100 may use the user interface input devices 138 to analyze the tests that have been developed for the product under development, as described below.

The architecture of the development system 100 may vary. For example, the application development system 102 and the test development system 104 may be provided as part of an IDE system, such as Visual Studio® available from Microsoft Corporation. In some cases, the product development system 102 and the test development system 104 are implemented in a team development environment in which a number of developers are implementing the systems via a number of processors (e.g., on different computing devices). The implementation of the product development system 102 and the test development system 104 may thus be distributed over any number of computing devices. In some cases, one or both of the product development system 102 and the test development system 104 are implemented in a client-server architecture. One or more of the above-described tools, features, components, or other elements of the development system 100 may be provided as a service over a network or other communication connection between a client device and a server device. For example, the test analysis tool 132 may be provided as a test analysis service by an application tier of a server. The data used or generated by such application services may be stored in a data tier of the server. The services and data may be received by a client device via a client proxy or other communication interface.

The development system 100 may include any number of additional processors, computers, devices, or other systems to generate various user interfaces or environments, including, for instance, separate development, end-user, or administrative environments for the product development system 102, the test development system 104, and/or the software system 116.

The development system 100 is configured to detect test similarity between tests of the software system 116. In the embodiment of FIG. 1, instructions for the test engine 124, the trace tools, and the test analysis tool 132 are stored in the memory 136 and/or the data storage device 140. For example, the processor 134 may retrieve the test engine instructions and the trace tool instructions from the data storage device 140 and store a representation of the instructions in the memory 136 for execution of the instructions. The test engine instructions may direct the processor 134 to run the tests developed by the test development system 104, while the trace tool instructions may direct the processor 134 to generate trace data during the execution of the tests. The processor 134 may run the tests in preparation for implementing a test similarity detection procedure. Alternatively, the trace data is already available and obtained by the processor 134, for instance, from the data storage device 140.

The test analysis tool instructions may configure the processor 134 to retrieve or obtain the trace data. The trace data may include data indicative of the method call sequences executed during each of the tests. The trace data may also include code coverage data and/or other trace data. In some examples, the code coverage data may be indicative of the portions of the binary code files 114 covered or implemented during execution of the tests. The test analysis tool instructions may then configure the processor to compare or evaluate the trace data to generate similarity scores for the tests. For example, similarity scores may be generated for each pair of tests. In some embodiments, the evaluation of the trace data may include a comparison of the respective method call sequences of each test pair and/or a comparison of the respective code coverage data of each test pair. The processor 134 may implement pairwise comparisons until all of the test pairs are evaluated. In some cases, the processor 134 generates the similarity score for each comparison before proceeding to the next pairwise comparison. In such cases, the similarity score may be used to prioritize or otherwise reduce the computation burden. For example, the processor 134 may determine that some pairs need not be tested in cases in which, for instance, two tests are deemed identical based on the similarity score.

The similarity scores may be determined in a variety of ways. For example, the similarity score may be indicative of similarity via a value or level on a scale or range, the distribution of which extends from zero overlap or similarity (e.g., 0% or 0.0) to complete overlap or identity (e.g., 100% or 1.0). The range may vary. The trace data may be compared to determine the amount of overlap or similarity.

In the example of FIG. 1, the trace data includes code coverage data provided by the code coverage tool 128. Such code coverage data may be indicative of whether a particular block of code was hit during the test. Code coverage data may also provide useful information about the structure of the code of the software product under development. The test analysis tool 132 may configure the processor 134 to implement a difference routine on the code coverage data generated during the tests. For example, the difference routine may implement a set intersection operation. Additional or alternative operations may be implemented in the routine. The output of the difference routine may provide an indication of the number of blocks hit in each test. The number of blocks common to, or overlapping, both tests may be used to generate a similarity score solely for the code coverage data. In one example, the code coverage similarity score is normalized by the number of blocks encountered in the first of two tests, t1 and t2, as follows: the code coverage similarity of tests t1 and t2 equals the number of common blocks between t1 and t2 divided by the number of blocks hit in t1.

The code coverage similarity score of some cases may not be associative, as the determination may depend on which test is considered the first test. In other examples, the code coverage similarity score may be normalized by, for instance, the maximum of the number of blocks encountered in the two tests.

The code coverage similarity score alone may not provide an accurate indication of the similarity of two tests. For instance, the code coverage data may not reflect how the blocks were hit over time during the tests. The tests may perform significantly different sequences of operations, despite a code coverage score that indicates a high degree of similarity. The two tests may be designed to test different functionalities of the software system 116. In such cases, alternative or additional trace data, such as the method call sequence data, may be useful to determine whether the tests are indeed similar. The method call sequence data may provide an indication of the order in which the code of the software system 116 is encountered or hit during a test. The method call sequence data may provide the temporal or other order information missing from the code coverage data. With such information, the test analysis tool 132 may determine with increased accuracy the extent to which two tests are redundantly or otherwise similarly performing the same functionality by comparing the two method call sequences in which the two tests encounter the code.

In some embodiments, the method call sequence analysis is performed only for those pairs of tests for which the code coverage analysis indicates a minimum level or degree of similarity. For example, the code coverage similarity score may be compared with a threshold to determine whether to perform the method call sequence analysis. Those pairs of tests found to be sufficiently similar in the code coverage analysis are then further analyzed for similarity in the method call sequence data. In some examples, such tests are re-run against the binary code of the software system 116 to generate the method call sequence data. Alternatively, the method call sequence data is collected or generated during the initial run of the tests.

The method call sequence data may be collected via a number of different tracing tools. For example, the IntelliTrace tool may be used in embodiments implemented in the Visual Studio® environment. In other embodiments, the method call sequence data may be collected via other tools.

The test analysis tool 132 may be configured to implement one or more sequence comparison procedures to quantify the degree of similarity between two sequences. A wide of variety of sequence analyzers may be used, including, for example, those configured to determine a Levenshtein distance. Alternatively or additionally, procedures or algorithms used to compare DNA sequences may be used to compute a distance or other metric indicative of the degree of similarity. The distance or other metric may be used to generate a method call sequence similarity score. To generate the score, the similarity metric determined by such procedures may be normalized as described above in connection with the code coverage similarity score. In an example that determines sequence similarity based on a Levenshtein distance, the score may calculated as follows: the method call sequence similarity of tests t1 and t2 equals the difference between the maximum length of the two method call sequences and the Levenshtein distance divided by the maximum length of the tests t1 and t2.

The test analysis tool 132 may configure the processor 134 to combine the similarity scores based on the individual types of trace data collected by the trace tools of the test development system 104. For example, the test analysis tool 132 may configure the processor 134 to generate a composite or aggregate similarity score that combines a code coverage similarity score and a method call sequence similarity score. The manner in which the code coverage similarity score and the method call sequence similarity score are aggregated or combined may vary. In some embodiments, the processor is further configured to execute the test analysis tool instructions to apply respective weights to the code coverage similarity score and the method call sequence similarity score, and to sum a weighted code coverage similarity score and a weighted method call sequence similarity score to generate the composite similarity score. The composite similarity score may correspond with the weighted sum of the individual similarity scores for tests t1 and t2 as follows: Similarity(t1, t2)=w1*Similarity_CC(t1, t2)+w2*Similarity_CS(t1, t2), where Similarity_CC corresponds with the code coverage score and Similarity_CS corresponds with the method call sequence score.

Using both code coverage and call sequence information to generate a composite similarity score may provide an accurate indication of which tests are redundant or otherwise similar. The indication may then be presented to developers or other users. A test developer may then use the information to either delete, merge, or otherwise modify tests that are similar. Duplicative or overlapping tests may thus be avoided, thereby removing impediments to the further development of the software system 116. Notwithstanding the foregoing, the test analysis tool 132 need not use both code coverage data and method call sequence data to generate a composite similarity score. The disclosed methods and systems may, for instance, be configured to generate a similarity score based on the method call sequence data alone, or In conjunction with one or more other types of trace data.

The test analysis tool 132 may compare the composite similarity score with one or more thresholds to characterize the extent to which a pair of tests is similar. For example, a pair of tests may be characterized as having strong similarity, moderate similarity, weak similarity, or zero similarity. The threshold comparison may alternatively or additionally be used to categorize or group the tests. In one example, the tests may be arranged in groups based on the degree of similarity. The groups may, for instance, correspond or be aligned with the strong, moderate, weak characterizations. Alternatively or additionally, each group may include all of the tests that have been deemed sufficiently similar to one another based on a threshold comparison. In such cases, each test grouping may assist a test developer in merging, removing, or otherwise revising multiple tests in the group, instead of addressing the tests on a pair-by-pair basis. The processor 134 may be configured by the test analysis tool 132 to direct the user interface devices 138 to display or otherwise present information indicative of the groupings, similarity characterizations, and/or other results of the analysis. In some cases, the user interface device 138 may include a display directed by the processor 134 to provide a user interface configured to present an alert (or other result) in accordance with whether the similarity score exceeds a threshold.

In some embodiments, the test analysis tool 132 may be configured to implement a sequence compression procedure during the method call sequence comparison. The sequence compression procedure may be an option presented to a user via the user interface device 138 to configure the test analysis. The sequence compression may address differences in method call sequences arising from loops or iterations implemented by the software system 116. The loops may lead to dissimilarity in the method call sequences that arise not necessarily from differences in the tests, but rather how many iterations of the loop are implemented based on the parameters specified for the tests. The following excerpt of software system source code provides one example in which such compression may be useful:

void Foo(int n)
{

for(int i = 0; i < n; i++)
{

Bar( );

}
Beep ( );

}

The code excerpt defines a method Foo that takes an integer n as an argument, which, in turn, establishes the number of iterations of a loop in which another method, Bar, is called. In this example, compression may be warranted if a test T1 called the method Foo with parameter 10 at run time and a test T2 called the method Foo with parameter 100, but otherwise the two tests are similar. The method call sequences may appear as follows:
T1: Foo, Bar, Bar . . . 6 times . . . Bar, Bar, Beep
T2: Foo, Bar, Bar . . . 96 times . . . Bar, Bar, Beep

In some cases, a test developer may consider the tests T1 and T2 to be highly similar in spite of the significant difference in call sequences. The sequence compression procedure may address the difference by analyzing the method call sequence data for each test to identify a pattern of repetitions. For example, the method call sequence data for the tests may be parsed and, after detection of the repetition, rewritten or stored with an identifier or other characterization of the repetition. In the example above, the tests T1 and T2 may be rewritten as follows: T1—Foo, Bar+, Beep; and, T2—Foo, Bar+, Beep. In this example, the + symbol is used as the repetition identifier. The identifier may vary. With the identifier replacing the repetition, a comparison of the sequences reveals the strong similarity. Such compression may be made available as a test analysis option in the test development system 104 via a checkbox or other command.

Further details regarding the generation of similarity scores are provided below in connection with a number of exemplary tests.

The functionality of the test analysis tool 132 may be integrated into a team or other development environment in which changes to the software system 116 and/or the test suite are controlled. In the example of FIG. 1, the version control system 110 may direct the processor 134 to control changes to the software system 116 by instituting check-in policies or other procedures. The test analysis tool 132 may be configured to initiate a test analysis upon detecting a check-in or other trigger event. In some embodiments, the trigger event involves a change to the software system 116. For example, the change may be associated with a build of the software system 116, or involve the completion of a story, sprint, milestone, or other stage in the development process. The frequency at which the test analysis is initiated may vary or be user-specified. Alternatively or additionally, the trigger event involves a change to the test suite, such as the addition of a new test or the modification of an existing test. The test analysis may be implemented upon detection of the trigger event, and/or provide a user with an option to initiate the test analysis. In an example in which the trigger event involves a new test, the user interface device 138 may then generate an alert if the new test is sufficiently similar to one or more existing tests. In these and other cases, the processor 134 may be further configured by the test analysis tool 132 to reject a check-in if the test analysis results in a similarity score that exceeds a threshold. Alternatively or additionally, the results of the test analysis may be presented in an alert.

The memory 136 and/or the data storage device 140 may include any number of data storage devices of varying types or other data stores or memories. Computer-readable instructions for each of the above-described tools, components, or elements of the product development system 102, the test development system 104, and the software system 116 may be stored in any manner across the data storage devices. For example, the computer-readable instructions may include test analysis tool instructions, trace tool instructions, compiler tool instructions, build tool instructions, version control instructions, and user interface rendering instructions. Data generated or resulting from the execution of such instructions may also be stored in any manner across the data storage devices. For example, the data storage devices may include one or more data stores in which data is stored during or after various operations, including, for instance, similarity score calculations, aggregation operations, and other operations in which data indicative of the test groups or test results are stored. Data for such calculations, groups, or results may be persisted in the data stores so that the data need not be re-generated.

The processor 134 may include any number of processors or processing systems. The processors or processing systems may be distributed among or across any number of computing devices, including, for instance, one or more server devices and one or more client devices.

The above-described tools may be implemented via graphical, textual, or other user interfaces. The tools may be implemented in a variety of user environments. For example, the tools may be controlled or implemented via a command line or other type of interface.

The tests analyzed by the disclosed methods and systems need not be implemented or run against binary code or representations of the software system 116. The software product under development may be represented by source code, intermediate code, or other code during testing.

FIG. 2 depicts an exemplary method for detecting similar software system tests. The method is computer-implemented. For example, the processor 134 shown in FIG. 1 may be configured to implement one or more of the acts of the method. The implementation of each act may be directed by respective computer-readable instructions executed by the processor 134 and/or another processor or processing system.

The method may begin with any number of acts directed to the development of a software product and/or tests (or unit tests or other test cases) for automated testing of the software product under development. In some cases, the method is implemented after such development. The method need not include any software or test development acts.

The method may begin with an act 200 in which a test analysis is initiated upon detecting a trigger event. The nature of the trigger event may vary. In some cases, the trigger event includes or involves a build or check-in of the software system. Alternatively or additionally, the trigger event may involve the detection of a new test that has yet to executed. The test analysis may be implemented automatically upon detection of the trigger event, or may be implemented after a user is alerted to the trigger event and given the option to authorize the test analysis.

In act 202, a number of tests are run or executed against the software system to generate or collect trace data. In some cases, the trace data is obtained or received from a previous test run. The act 202 may include an act 204 in which code coverage data is collected and/or an act 206 in which method call sequence data is collected. Such data may be collected for each test associated with the software system, or for only a selected number of tests, or other subset of tests. The collection of such data may involve the implementation of one or more test tools as described above. The code coverage data, method sequence data, or other trace data may be received via any processing or communication technique.

Similarity scores for each pair of tests for which the trace data is available may then be generated in act 208. The generation of the similarity scores may be achieved via a processor or processing system as described herein. The similarity scores may be based on a comparison or an evaluation of the trace data in act 210. Individual similarity scores may be generated for the respective types of trace data. For example, a code coverage similarity score and a method call sequence similarity score may be generated. The method call sequence data may be compared or evaluated after the sequence data is processed for possible compression in act 212. Respective weights may be applied to the code coverage similarity score and the method call sequence similarity score in act 214 before the individual scores are aggregated in act 216 to generate the similarity score. Aggregation may thus include summing a weighted code coverage similarity score and a weighted method call sequence similarity score, in some cases. The weights may be specified by a user or set to default values (e.g., 0.5 for each of the two types of trace data) via a user interface option.

In act 218, the similarity score are compared with one or more thresholds. Respective thresholds may be defined for various characterizations of the degree of similarity, such as strong similarity, moderate similarity, and weak similarity. A threshold may alternatively or additionally be established to determine whether an alert or other action or result is warranted based on the similarity score.

After the threshold comparisons, one or more user interfaces are generated or rendered in act 220 to present or provide one or more results of the test analysis. The results are based on the generated similarity scores. The content, nature, and other characteristics of the results may vary. In the embodiment of FIG. 2, one or more test groups are defined and presented via the user interface in an act 222 based on the degree of similarity and/or a common similarity (e.g., all of the test within a respective group exhibit at least a certain level of similarity to one another). Alternatively or additionally, an alert is generated and sent or provided via the user interface in act 224 regarding tests having a similarity that exceeds a threshold. In some cases, a check-in (e.g., of a new test or otherwise for the software system) may rejected in an act 226 if the similarity score exceeds a threshold.

The order of the acts of the method may vary. For example, code coverage data may be obtained and evaluated for each test before the collection of method call sequence data. Similarity scores for the code coverage data may be generated before the collection of method call sequence data.

An example of the implementation of one embodiment of the disclosed methods and systems is set forth below. In this example, a software system includes an Employee class being tested. The Employee class may include the following source code to be tested by a number of test cases. The source code includes a number of methods that may be called during execution of the source code, including an Employee method, a ChangeManager method, and a ChangeTitle method. The source code may be written via the code editor 106 (FIG. 1) and compiled for execution via the compiler and/or other build tools 108 (FIG. 1).

public class Employee

{

public int Id { get; private set; }
public int ManagerId { get; private set; }
public string Title { get; private set; }
public Employee(int id)
{

this.Id = id;

}
public void ChangeManager(int managerId)
{

if (managerId == this.Id)
{

// Cannot manage yourself
throw new ApplicationException(“Cannot be your own
manager”);

}
this.ManagerId = managerId;

}
public void ChangeTitle(string title)
{

if (string.IsNullOrEmpty(title))
{

throw new ArgumentException( );

}
this.Title = title;

}

}

The functionality of the foregoing source code is tested via the test code of the following tests. The test code may be written via the test editor 120 (FIG. 1) and implemented via the test execution engine 124 (FIG. 1). In this example, the tests are directed to the testing the functionality of the Employee class of the software system. The tests specify a number of methods defined in an EmployeeTests class, including a CreateEmployee method test, a CreateAnotherEmployee method test, a BeYourOwnManager method test, a ChangeManager method test, a ChangeManagerManyTimes method test, and a ChangeTitle method test.

[TestClass]

public class EmployeeTests
{

[TestMethod]
public void CreateEmployee( )
{

Employee emp = new Employee(10);
Assert.AreEqual(10, emp.Id);

}
[TestMethod]
public void CreateAnotherEmployee( )
{

Employee emp2 = new Employee(15);
Assert.AreEqual(10, emp2.Id);

}
[TestMethod, ExpectedException(typeof(ArgumentException))]
public void BeYourOwnManager( )
{

Employee emp = new Employee(10);
emp.ChangeManager(10);

}
[TestMethod]
public void ChangeManager( )
{

Employee emp = new Employee(10);
emp.ChangeManager(20);
Assert.AreEqual(emp.ManagerId, 20);
Assert.AreEqual(emp.Id, 10);

}
[TestMethod]
public void ChangeManagerManyTimes( )
{

Employee emp = new Employee(10);
emp.ChangeManager(20);
Assert.AreEqual(emp.ManagerId, 20);
emp.ChangeManager(30);
Assert.AreEqual(emp.ManagerId, 30);
emp.ChangeManager(40);
Assert.AreEqual(emp.ManagerId, 40);
emp.ChangeManager(50);
Assert.AreEqual(emp.ManagerId, 50);
emp.ChangeManager(60);
Assert.AreEqual(emp.ManagerId, 60);
emp.ChangeManager(70);
Assest.AreEqual(emp.ManagerId, 70);

}
[TestMethod]
public void ChangeTitle( )
{

Employee emp = new Employee(10);
emp.ChangeTitle(“CEO”);
Assert.AreEqual(emp.Title, “CEO”);

}

}

Two of the above tests present an example of identical or identically redundant tests. For the tests CreateEmployee and CreateAnotherEmployee, the code coverage similarity and the method call sequence similarity scores are both 100%. That is, Similarity_CC(CreateEmployee, CreateAnotherEmployee)=1/1=1 (100%) and Similarity_CS(CreateEmployee, CreateAnotherEmployee)=1 (100%), for a composite similarity of 100%, where the variable Similarity_CC is representative of similarity based on code coverage and the variable Similarity_CS is representative of similarity based on call sequence data.

The tests CreateEmployee and BeYourOwnManager provide an example of where code coverage data alone may be insufficient to determine the extent to which the tests are redundant. There, a comparison of the CreateEmployee test with respect to the BeYourOwnManager test yields the following: Similarity_CC(CreateEmployee, BeYourOwnManager)=1/1=1 (100%), but Similarity_CS(CreateEmployee, BeYourOwnManager)=0.5 (50%), for a composite similarity score of 75%. The two tests are similar in terms of code coverage, but only marginally similar in method call sequence. The code coverage similarity in this example also exhibits how the similarity calculation (as defined in the example above) may not be associative, and may thus depend on the ordering of the comparison. Another example of method call sequence data revealing underlying differences involves the tests ChangeManager and ChangeManagerManyTimes, which have a code coverage similarity score of 100% and a method call sequence similarity score of 28%, for a composite similarity score of 64%.

A comparison of ChangeManager and ChangeTitle yields a code coverage similarity score of 33% and a method call sequence similarity score of 50%, for a composite similarity score of 41.5%.

In one example, the development system in which the foregoing tests are developed and implemented may then be configured to provide an alert or other result that identifies those tests having composite similarity scores exceeding a threshold of 50%.

The foregoing tests provide one example of the manner in which the disclosed methods and systems may be used to facilitate removal or other modifications to the tests. For example, the test duplication or other similarity information provided by the disclosed methods and systems may be used by developers to remove or merge tests. Duplicative coverage in the test bed or suite may be reduced or eliminated. Such modifications may lead to faster test runs, quicker feedback for code changes, and/or better software system maintainability.

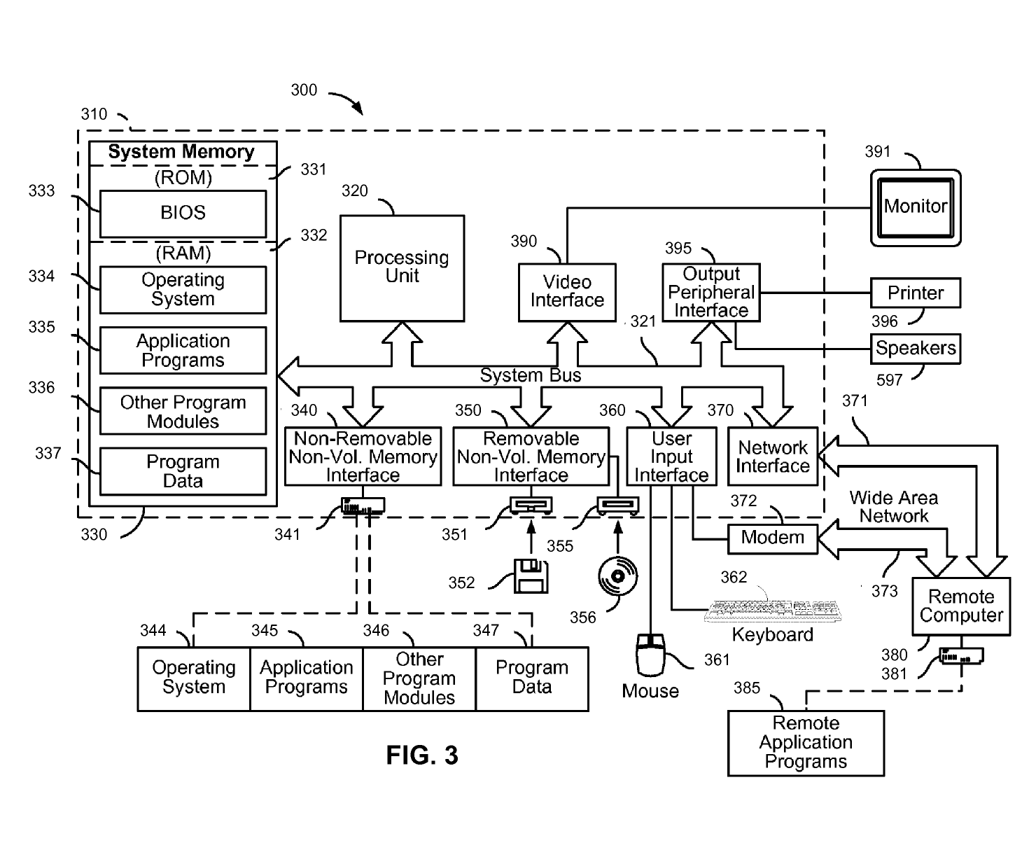

With reference to FIG. 3, an exemplary computing environment 300 may be used to implement one or more aspects or elements of the above-described methods and/or systems. The computing environment 300 of FIG. 3 may be used by, or incorporated into, one or more elements of the system 100 (FIG. 1). For example, the computing environment 300 may be used to implement the product development system 100 and/or the test development system 104. The computing environment 300 may be used or included as a client, network server, application server, or database management system or other data store manager, of any of the aforementioned elements or system components. The computing environment 300 may be used to implement one or more of the acts described in connection with FIG. 2.

The computing environment 300 includes a general purpose computing device in the form of a computer 310. Components of computer 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. The units, components, and other hardware of computer 310 may vary from the example shown.

Computer 310 typically includes a variety of computer readable storage media configured to store instructions and other data. Such computer readable storage media may be any available media that may be accessed by computer 310 and includes both volatile and nonvolatile media, removable and non-removable media. By way of example, and not limitation, such computer readable storage media may include computer storage media as distinguished from communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may accessed by computer 310.

The system memory 330 includes computer storage media in the form of volatile and/or nonvolatile memory such as read only memory (ROM) 331 and random access memory (RAM) 332. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336, and program data 337. For example, one or more of the application programs 335 may be directed to implementing the test analysis tool instructions. Alternatively or additionally, the test analysis tool instructions may be implemented via one or more of the other program modules 336. In this or another example, any one or more the instruction sets in the above-described memories or data storage devices may be stored as program data 337.

Any one or more of the operating system 334, the application programs 335, the other program modules 336, and the program data 337 may be stored on, and implemented via, a system on a chip (SOC). Any of the above-described modules may be implemented via one or more SOC devices. The extent to which the above-described modules are integrated in a SOC or other device may vary.

The computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350.

The drives and their associated computer storage media discussed above and illustrated in FIG. 3, provide storage of computer readable instructions, data structures, program modules and other data for the computer 310. In FIG. 3, for example, hard disk drive 341 is illustrated as storing operating system 344, application programs 345, other program modules 346, and program data 347. These components may either be the same as or different from operating system 334, application programs 335, other program modules 336, and program data 337. Operating system 344, application programs 345, other program modules 346, and program data 347 are given different numbers here to illustrate that, at a minimum, they are different copies. A user may enter commands and information into the computer 310 through input devices such as a keyboard 362 and pointing device 361, commonly referred to as a mouse, trackball or touch pad. Other input devices (not shown) may include a microphone (e.g., for voice control), touchscreen (e.g., for touch-based gestures and other movements), ranger sensor or other camera (e.g., for gestures and other movements), joystick, game pad, satellite dish, and scanner. These and other input devices are often connected to the processing unit 320 through a user input interface 360 that is coupled to the system bus, but may be connected by other interface and bus structures, such as a parallel port, game port or a universal serial bus (USB). A monitor 391 or other type of display device is also connected to the system bus 321 via an interface, such as a video interface 390. In addition to the monitor, computers may also include other peripheral output devices such as speakers 397 and printer 396, which may be connected through an output peripheral interface 395.

The computer 310 may operate in a networked environment using logical connections to one or more remote computers, such as a remote computer 380. The remote computer 380 may be a personal computer, a server, a router, a network PC, a peer device or other common network node, and typically includes many or all of the elements described above relative to the computer 310, although only a memory storage device 381 has been illustrated in FIG. 3. The logical connections depicted in FIG. 3 include a local area network (LAN) 371 and a wide area network (WAN) 373, but may also include other networks. Such networking environments are commonplace in offices, enterprise-wide computer networks, intranets and the Internet.

When used in a LAN networking environment, the computer 310 is connected to the LAN 371 through a network interface or adapter 370. When used in a WAN networking environment, the computer 310 typically includes a modem 372 or other means for establishing communications over the WAN 373, such as the Internet. The modem 372, which may be internal or external, may be connected to the system bus 321 via the user input interface 360, or other appropriate mechanism. In a networked environment, program modules depicted relative to the computer 310, or portions thereof, may be stored in the remote memory storage device. By way of example, and not limitation, FIG. 3 illustrates remote application programs 385 as residing on memory device 381. It will be appreciated that the network connections shown are exemplary and other means of establishing a communications link between the computers may be used.

The computing environment 300 of FIG. 3 is only one example of a suitable computing environment and is not intended to suggest any limitation as to the scope of use or functionality of the technology herein. Neither should the computing environment 300 be interpreted as having any dependency or requirement relating to any one or combination of components illustrated in the exemplary operating environment 300.

The technology described herein is operational with numerous other general purpose or special purpose computing system environments or configurations. Examples of well-known computing systems, environments, and/or configurations that may be suitable for use with the technology herein include, but are not limited to, personal computers, server computers (including server-client architectures), hand-held or laptop devices, mobile phones or devices, multiprocessor systems, microprocessor-based systems, set top boxes, programmable consumer electronics, network PCs, minicomputers, mainframe computers, distributed computing environments that include any of the above systems or devices, and the like.

The technology herein may be described in the general context of computer-executable instructions, such as program modules, being executed by a computer. Generally, program modules include routines, programs, objects, components, data structures, and so forth that perform particular tasks or implement particular abstract data types. The technology herein may also be practiced in distributed computing environments where tasks are performed by remote processing devices that are linked through a communications network. In a distributed computing environment, program modules may be located in both local and remote computer storage media including memory storage devices.

While the present invention has been described with reference to specific examples, which are intended to be illustrative only and not to be limiting of the invention, it will be apparent to those of ordinary skill in the art that changes, additions and/or deletions may be made to the disclosed embodiments without departing from the spirit and scope of the invention.

The foregoing description is given for clearness of understanding only, and no unnecessary limitations should be understood therefrom, as modifications within the scope of the invention may be apparent to those having ordinary skill in the art.

What is claimed is:

1. A computer-implemented method for detecting test similarity between first and second tests for a software system, the computer-implemented method comprising:
receiving data indicative of respective method call sequences executed during each of the first and second tests;
generating, with a processor, a similarity score for the first and second tests based on a comparison of the respective method call sequences; and
providing, via a user interface, a result of the comparison based on the similarity score.

2. The computer-implemented method of claim 1, wherein:
the data is further indicative of respective code coverages achieved during each of the first and second tests; and
the similarity score is further based upon a comparison of the respective code coverages.

3. The computer-implemented method of claim 1, further comprising executing the first and second tests against the software system to generate trace data, wherein the comparison comprises an evaluation of the trace data.

4. The computer-implemented method of claim 1, wherein the data comprises trace data generated during execution of the first and second tests, and wherein generating the similarity score comprises:
generating a code coverage similarity score based on the trace data;
generating a method call sequence similarity score based on the trace data; and
aggregating the code coverage similarity score and the method call sequence similarity score to generate the similarity score.

5. The computer-implemented method of claim 4, wherein:
generating the similarity score further comprises applying respective weights to the code coverage similarity score and the method call sequence similarity score; and
aggregating the code coverage similarity score and the method call sequence similarity score comprises summing a weighted code coverage similarity score and a weighted method call sequence similarity score.

6. The computer-implemented method of claim 1, further comprising comparing the similarity score with a threshold, wherein providing the result comprises generating an alert if the similarity score exceeds the threshold.

7. The computer-implemented method of claim 1, further comprising initiating a test analysis of the first and second tests upon detecting a trigger event.

8. The computer-implemented method of claim 7, wherein the trigger event comprises a build of the software system.

9. The computer-implemented method of claim 7, wherein the trigger event comprises a check-in for the software system.

10. The computer-implemented method of claim 9, further comprising rejecting the check-in if the similarity score exceeds a threshold.

11. A system for detecting test similarity between first and second tests for a software system, the system comprising:
a memory in which test analysis tool instructions are stored;
a processor coupled to the memory and configured to execute the test analysis tool instructions to:
obtain data indicative of respective method call sequences executed during each of the first and second tests;
generate a similarity score for the first and second tests based on an evaluation of the respective method call sequences; and
compare the similarity score with a threshold; and
a display coupled to the processor to provide a user interface configured to present a result in accordance with whether the similarity score exceeds the threshold.

12. The system of claim 11, wherein:
the data is further indicative of respective code coverages achieved during each of the first and second tests; and
the similarity score is further based upon a comparison of the respective code coverages.

13. The system of claim 11, wherein:
the memory comprises test engine instructions and trace tool instructions for execution of the first and second tests against the software system and for generation of trace data during the execution, respectively; and
the evaluation comprises a comparison of the trace data.

14. The system of claim 11, wherein:
the data comprises trace data generated during execution of the first and second tests; and
the test analysis tool instructions configure the processor to generate a code coverage similarity score based on the trace data, to generate a method call sequence similarity score based on the trace data, and to aggregate the code coverage similarity score and the method call sequence similarity score to generate the similarity score.

15. The system of claim 14, wherein the processor is further configured to execute the test analysis tool instructions to apply respective weights to the code coverage similarity score and the method call sequence similarity score, and to sum a weighted code coverage similarity score and a weighted method call sequence similarity score to generate the similarity score.

16. The system of claim 11, wherein the processor is further configured to execute the test analysis tool instructions to initiate a test analysis of the first and second tests upon detecting a trigger event, the trigger event comprising a check-in for the software system.

17. The system of claim 16, wherein the processor is further configured to execute the test analysis tool instructions to reject the check-in if the similarity score exceeds a threshold.

18. A computer program product comprising one or more computer-readable storage media in which computer-readable instructions are stored that, when executed by a processing system, direct the processing system to:
execute first and second tests of a software system;
receive respective trace data for the first and second tests, the trace data being indicative of a respective code coverage and a respective method call sequence achieved during execution of the first and second tests;
evaluate the trace data for the first and second tests to generate a code coverage similarity score and a method call sequence similarity score for the first and second tests;
aggregate the code coverage similarity score and the method call sequence similarity score to determine a similarity score for the first and second tests; and
generate a user interface to provide a result based on the similarity score.

19. The computer program product of claim 18, wherein the computer-readable instructions further direct the processing system to apply respective weights to the code coverage similarity score and the method call sequence similarity score, such that the similarity score is determined by a sum of a weighted code coverage similarity score and a weighted method call sequence similarity score.

20. The computer program product of claim 18, wherein the computer-readable instructions further direct the processing system to execute the first and second tests upon detecting a trigger event, the trigger event comprising a check-in for the software system, and to reject the check-in if the similarity score exceeds a threshold.
